(19) United States
(12) Patent Application Publication
(10) Pub. No.: US 2002/0178024 A1
(43) Pub. Date: Nov. 28, 2002

(54) Eating and drinking charge management method, program, system and medium

(75) Inventor: Akihisa Terakoshi, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/096,643

(22) Filed: Mar. 14, 2002

(30) Foreign Application Priority Data
May 28, 2001 (JP) 2001-158805

(51) Int. Cl. G06F 17/60

(52) U.S. Cl. 705/1; 705/418

(57) ABSTRACT

An eating and drinking charge management system comprises a time measuring unit (4) measuring a seat occupied time for which a customer eats and drinks, and a unit (2) setting a charge for eating and drinking in accordance with the seat occupied time.

### BACKGROUND OF THE INVENTION

The present invention relates to a technology of managing a charge for eating and drinking at a restaurant. The restaurants have hitherto been established on bustling streets and office streets in the great majority of cases. The bustling streets are crowded with people and easy to invite customers. Further, on the office streets, the restaurants can make regular customers at the lunch time and after duties.

Such bustling and office streets generally have, however, high land prices. Therefore, costs for opening the shop and a rental fee are liable to rise. Hence, what is required especially of the restaurant having good geographical conditions is to efficiently recover the costs for opening the shop and the rental fee for the shop.

Accordingly, there have hitherto been made schemes for recovering these expenditures by a variety of methods. For example, dishes each having a comparatively high unit price are often offered on the bustling streets. Further, there are many restaurants in a service fee is padded at a fixed rate to the charge for eating and drinking by the customer.

On the other hand, a quantitative expansion oriented solution is taken in many cases by the restaurants on the office streets by inviting a multiplicity of regular customers at comparatively low prices. To be specific, more customers are ushered to more table seats in a limited space than usual, thus scheming to increase proceedings.

The meal style used to be taken at the restaurant does not, however, have such a system that a charge for the meal is set corresponding to a time for which customer occupies the table and the seat. Therefore, for instance, a smorgasbord restaurant and a restaurant offering an All-You-Can-Eat service have been adopting a system for setting a time limit and giving this time limit to the customer staying for a long period of time.

In any case, there is no difference in charge for the meal between the customer finishing the meal in a comparatively short time and the customer finishing the meal in a comparatively long time among the customers who ordered the same dish. Hence, a cost recovery efficiency of the restaurant is different for every customer, depending on the table/seat occupied time. While on the other hand, the customers have no incentive to finish the meals in the short time.

### SUMMARY OF THE INVENTION

It is a primary object of the present invention, which was devised to obviate the problems inherent in the prior art, to provide an eating and drinking charge management technology capable of increasing a customer-based turnover rate at a restaurant.

To accomplish the above object, according to one aspect of the present invention, an eating and drinking charge management method comprises measuring a seat occupied time for which a customer eats and drinks (S4 through S9), and setting a charge for eating and drinking in accordance with the seat occupied time (S10 and S11).

Preferably, the eating and drinking charge management method may further comprise receiving a first notification indicating a start of eating and drinking (S5), and receiving a second notification indicating a completion of eating and drinking (S8), and measuring the seat occupied time may involve starting counting a time upon the first notification, and finishing counting the time upon the second notification.

Preferably, the eating and drinking charge management method may further comprise referring to a standard eating/drinking time for a dish and to a deviation charge corresponding to a deviation time from the standard time (S1050 through S1060), and setting the charge may involve increasing or decreasing the charge for eating and drinking on the basis of a deviation of the seat occupied time of the customer from the standard eating/drinking time for the dish eaten (and drunk) by the customer.

According to another aspect of the present invention, an eating and drinking charge management system comprises a time measuring unit (4) measuring a seat occupied time for which a customer eats and drinks, and a unit (2) setting a charge for eating and drinking in accordance with the seat occupied time.

Preferably, the eating and drinking charge management system may further comprise a first input unit (8) inputting an eating/drinking start notification indicating a start of eating and drinking, and a second input unit (8) inputting an eating/drinking completion notification, and the time measuring unit (4) may start counting a time upon the eating/drinking start notification, and finishing counting the time upon the eating/drinking completion notification.

Preferably, the eating and drinking charge management system may further comprise a unit (5) storing a standard eating/drinking time for a dish and a deviation charge corresponding to a deviation time from the standard time, and the setting unit (2) may increase or decrease the charge for eating and drinking by obtaining a deviation charge from a deviation of the seat occupied time of the customer from the standard eating/drinking time for the dish eaten (and drunk) by the customer.

According to a further aspect of the present invention, there is provided a program executed by a computer to actualize any one of the functions described above.

According to a still further aspect of the present invention, there is provided a readable-by-computer recording medium recorded with such a program executed by the computer.

As explained above, according to the present invention, a customer at a restaurant is given an incentive to finish eating and drinking in a comparatively short time. Therefore, according to the present invention, a customer-based turnover rate of the restaurant can be increased.

### BRIEF DESCRIPTION OF THE DRAWINGS

FIG. 1 is a diagram showing a whole architecture of an eating and drinking charge management system in an embodiment of the present invention;

FIG. 2 is a diagram showing a data structure of a cooking database;

FIG. 3 is a diagram showing data structure of a time table;

FIG. 4 is a diagram showing a data structure of an order management database;

FIG. 5 is a flowchart showing processes from serving dishes up to transmitting a notification of an end of the meal;

FIG. 6 is a flowchart showing a settlement of charge in detail; and

FIG. 7 is a flowchart showing details of a charge figure-out process in the settlement of charge.

### DETAILED DESCRIPTION OF THE PREFERRED EMBODIMENT

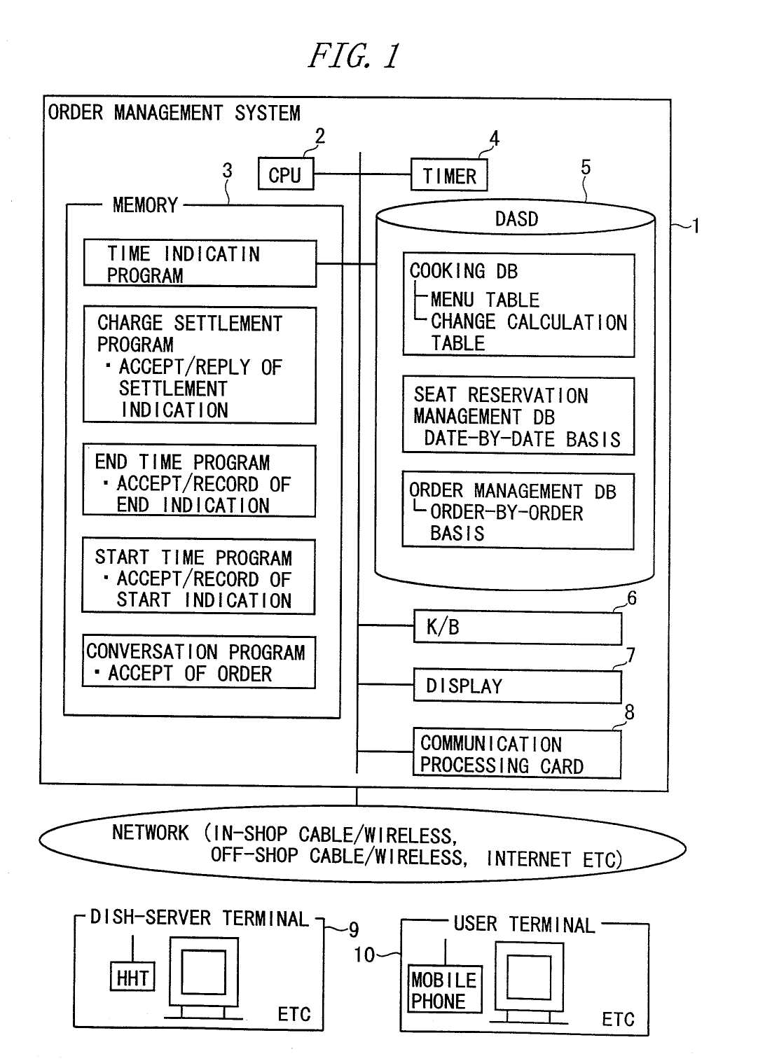

An embodiment of the present invention will hereinafter be discussed with reference to the drawings in FIGS. 1 through 7.

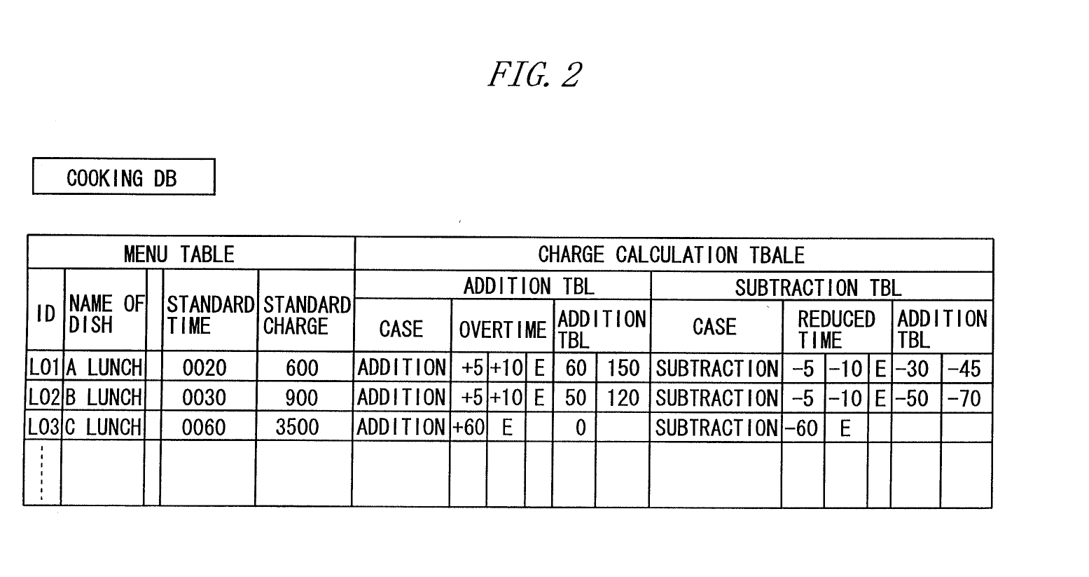

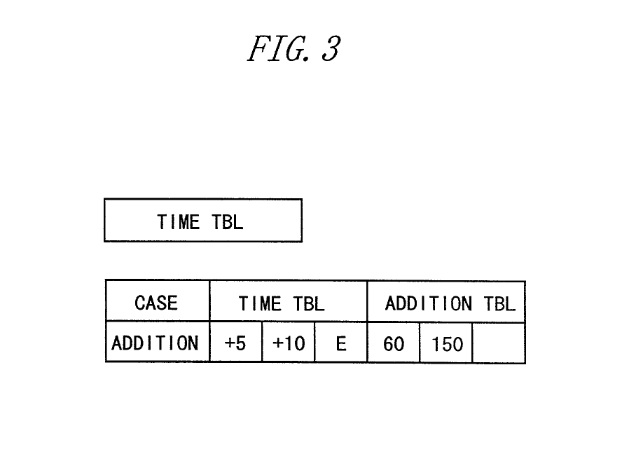

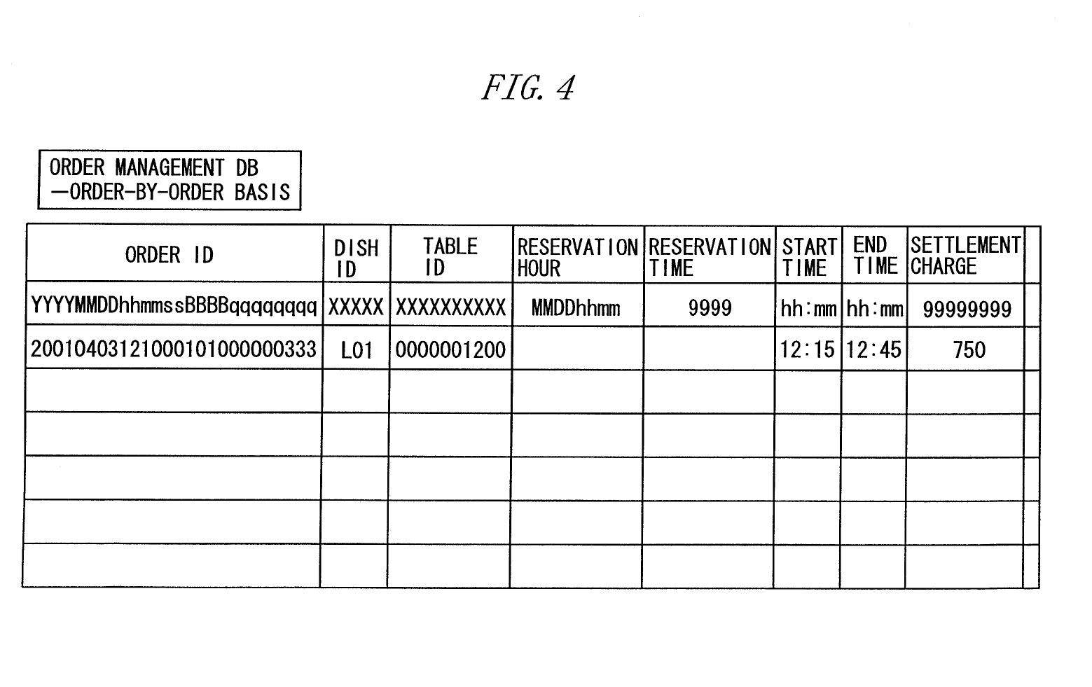

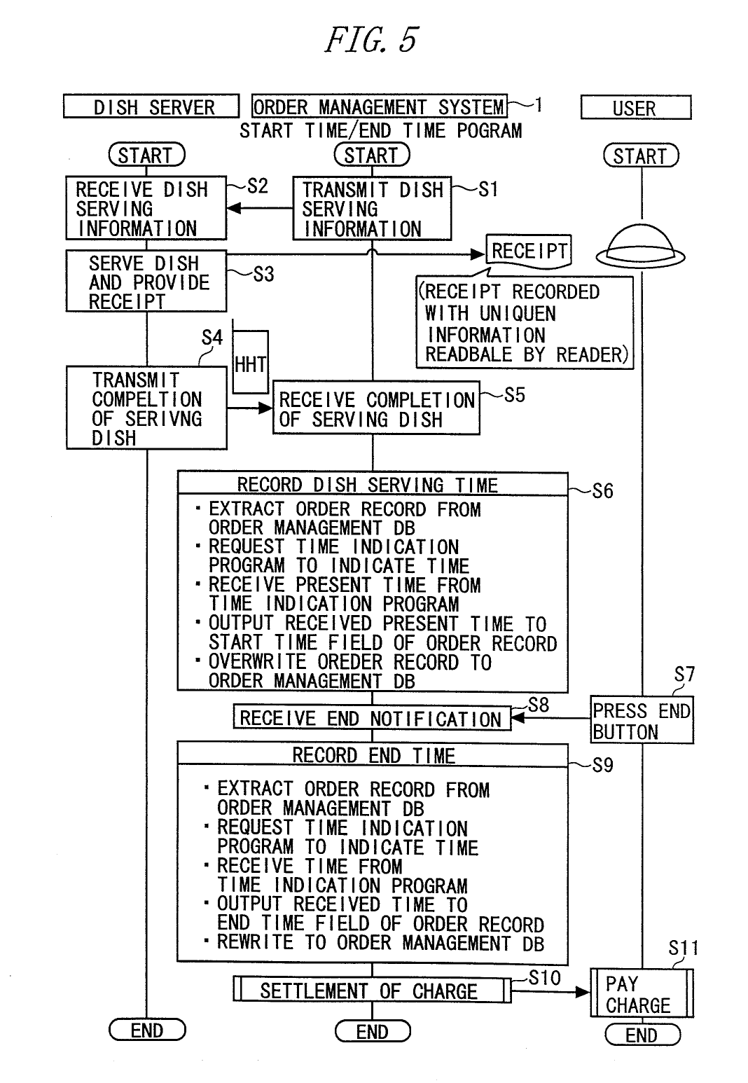

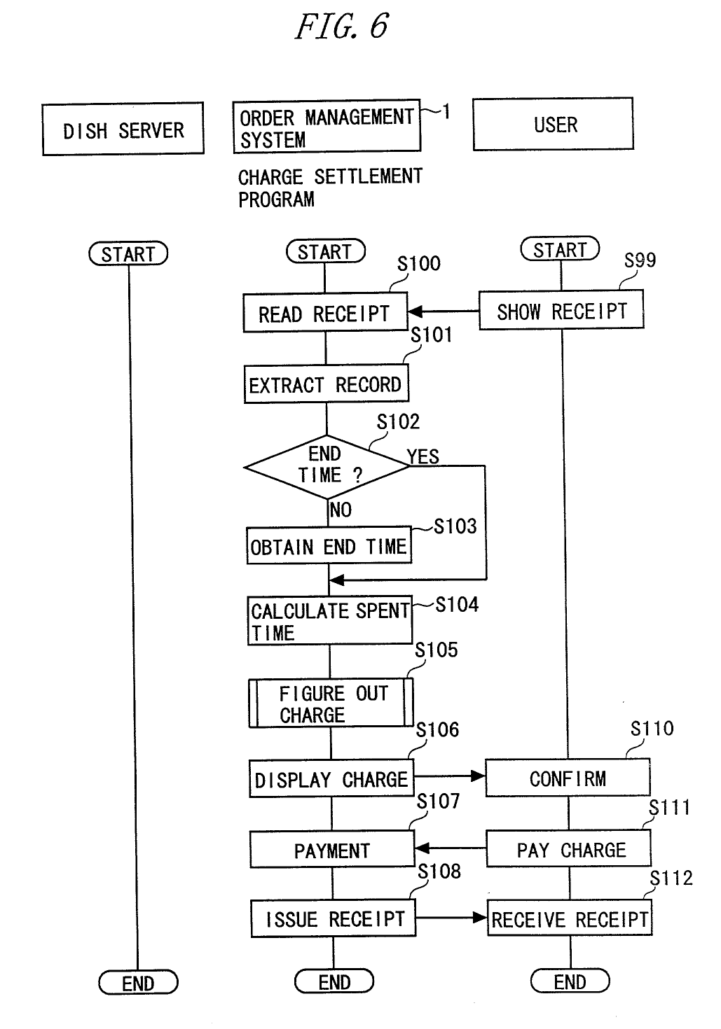

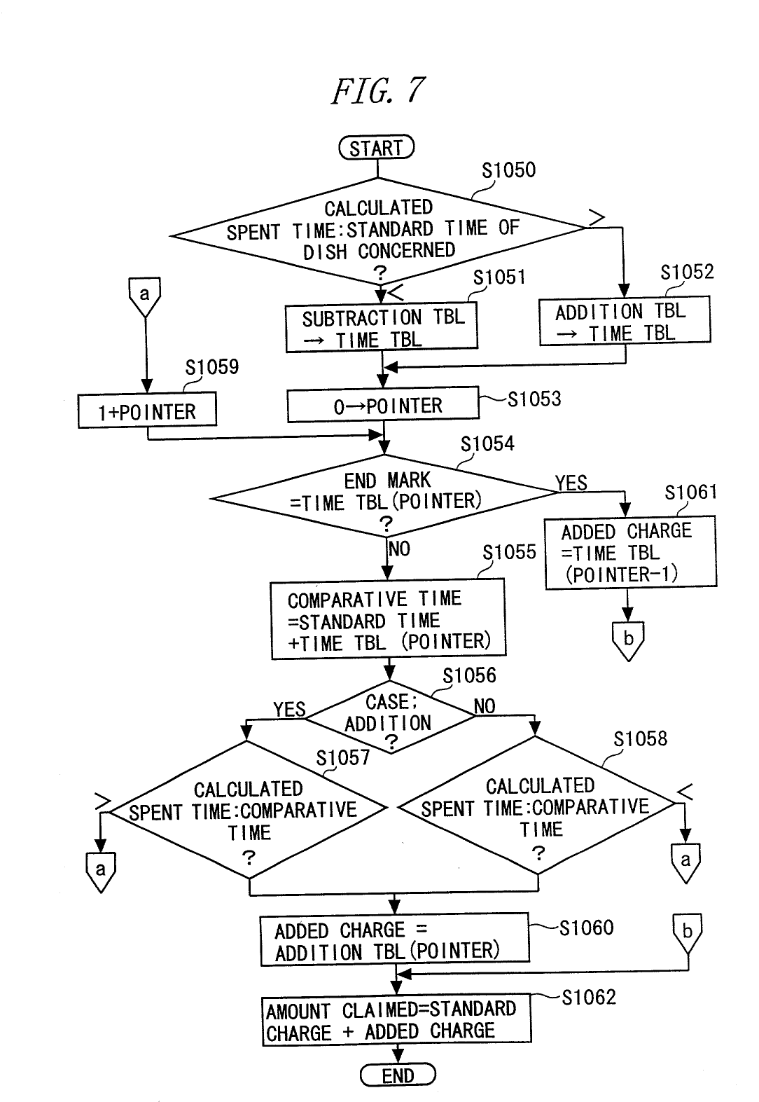

FIG. 1 is a diagram showing a whole architecture of an eating and drinking charge management system in the embodiment of the present invention. FIG. 2 is a diagram showing a data structure of a cooking database shown in FIG. 1. FIG. 3 is a diagram showing data structure of a time table used when a CPU 2 executes a charge settlement program. FIG. 4 is a diagram showing a data structure of an order management database shown in FIG. 1. FIG. 5 is a flowchart showing processes from serving dishes up to transmitting a notification of an end of the meal. FIG. 6 is a flowchart showing a settlement of charge (S10 and S11 in FIG. 5) in detail. FIG. 7 is a flowchart showing details of a charge figure-out process (S105 in FIG. 6) in the settlement of charge.

<System Architecture>

FIG. 1 illustrates the whole architecture of the present eating and drinking charge management system. Functions of this system are provided by an order management system 1 for managing orders at a restaurant.

The order management system 1 includes a CPU 2 for executing programs, a memory 3 for storing the programs executed by the CPU 2 and data processed by the CPU 2, a timer 4 for counting a time, a DASD (Direct Access Storage Drive) 5 for recording the programs and the data, a keyboard 6 used for a user to input the data, a display 7 for displaying the information to the user, and a communication processing card 8 used for accessing a network.

The CPU 2 executes the programs stored in the memory 3, thereby providing functions of the order management system 1.

The memory 3 is stored with the programs executed by the CPU 2 and the data processed by the CPU 2. Referring to FIG. 1, these programs may be exemplified such as a time indication program, a charge settlement program, an end time program, a start time program and a conversation program. The end time program, the start time program and the conversation program among those programs are defined as application programs for providing the functions of the order management system 1.

The time indication program controls the timer 4 via unillustrated OS (Operating System) to notify various categories of application programs of the present time.

The charge settlement program runs to execute, upon receiving a settlement indication after an end of the meal of a user, a charge settlement process. The end time program accepts a notification of the end of the meal, and records its end time in an order management database of the DASD 5. The start time program accepts a notification of a start of the meal, and records its start time in the order management database of the DASD 5. The conversation program accepts an order from an employee at the restaurant and an order from the user at the restaurant, and records the orders in the order management database and a seat reservation database.

The timer 4 is started by the CPU 2 an provides the CPU 2 with time information.

The DASD 5 records the programs executed by the CPU 2 and the data processed by the CPU 2. Referring again to FIG. 1, these pieces of data are stored in the cooking database (the data base is abbreviated to DB in FIG. 1), the seat reservation management database and the order management database.

The cooking database is structured of a menu table for recording names of dishes and prices thereof, and a charge calculation table for calculating a charge of the user. Further, the seat reservation management database is recorded with states of reservations on a date-by-date (time) and seat-by-seat basis. Moreover, the order management database is recorded with the orders of the users on an order-by-order basis.

The keyboard 6 is used for the user to input the character data. The display 7 displays a result of processing by the CPU 1 and contents of the various categories of databases.

The communication processing card 8 is used for sending the communication data to the network in response to a command from the CPU 2, and receiving the communication data from the network and transferring the same data to the CPU 2.

The order management system 1 accesses the network via the communication processing card 8. Then, the order management system 1 communicates with a dish-server terminal 9 used by the employee at the restaurant via the network, or with a user terminal 10 used by the user.

The network is, for example, a cable network, a cable LAN (Local Area Network), a wireless network, or a wireless LAN in the restaurant, a cable network, a wireless network or the Internet which are connected to the outside of the restaurant.

The dish-server terminal 9 is a hand-held terminal (that is abbreviated to an HHT in FIG. 1), a PDA (Personal Digital Assistant), a personal computer and others. The employee at the restaurant, when receiving the order at each table, inputs menu items of the ordered dishes, the number of dishes ordered, a table number etc through the dish-server terminal 9. A result of this input is transmitted to the order management system 1 and recorded in the order management database of the DASD 5.

The user terminal 10 is, e.g., a mobile telephone, the PDA, the personal computer etc. The user accesses the order management system 1 through the user terminal 10 and reserves the dishes beforehand. The reservation information is recorded on the order management database trough the conversation program.

<Data Structure>

FIG. 2 shows the data structure of the cooking database. As shown in FIG. 2, each of records (each of the records in the database consists of items of data in every line in FIG. 2) in this database, consists of data entered in an “ID” field, a “name of dish” field, a “standard time” field, a “standard charge” field, an addition table” field suite (the table is abbreviated to TBL in FIG. 2) and a “subtraction table” field suite. Each record in this cooking database corresponds to the management information of one dish (an item of menu).

A menu table is structured particularly of the data entered in the “ID”, “name of dish”, “standard time” and “standard charge” fields among those fields. The “ID” field is stored with a unique code for identifying each record, i.e., each menu item in the cooking database. Further, the “name of dish” field is stored with a name of dish managed by this ID.

Further, the “standard time” field is stored with a standard meal time when having (eating and driving) this dish. Moreover, the “standard charge” field is stored with an eating/drinking (meal) charge when having this dish in the standard time.

The addition table and the subtraction table in FIG. 2 are generically called a charge calculation table. This charge calculation table is recorded with the information for the CPU 2 to calculate a charge.

The addition table is recorded with the information for calculating a charge when the user ate and drank over the standard time. This “addition table” field suite includes a “CASE” field, an “overtime” field and an “addition table” field.

In the addition table, an “addition” is specified in the “CASE” field. The “overtime” field includes a plurality of elements recorded with a plurality of overtimes, e.g., +5, +10 etc. Further, the “addition table” field includes a plurality of elements corresponding to the elements in the “overtime” field and recorded with added amounts of money that correspond to the overtimes.

Similarly, the subtraction table is recorded with the information for calculating a charge when the user ate and drank in a reduced time shorter than the standard time. This “subtraction table” field suite includes a “CASE” field, a “reduced time” field and an “addition table” field.

In the subtraction table, a “subtraction” is specified in the “CASE” field. The “reduced time” field includes a plurality of elements recorded with a plurality of reduced times, e.g., −5, −10 etc. Further, in this case, the “addition table” field includes a plurality of elements corresponding to the elements in the “reduced time” field and recorded with added amounts of money as negative values that correspond to the reduced times.

FIG. 3 shows the data structure of the time table. The time table is a table used as an operation area when the CPU executes the charge settlement program. The data structure (the field structure in each line) of this time table is the same as the addition table or the subtraction table of the cooking database described above. When calculating the charge, the data in any one of the lines in the addition table or the subtraction table are copied to the time table, depending on the category of the dish and whether the meal is overtime, and are used as parameters for calculating the charge.

FIG. 4 shows the data structure of the order management database. Pieces of data of each of records (each line in FIG. 4 corresponds to one record in the database) are entered in an “order ID” field, a “dish ID” field, a “table ID” field, a “reservation hour” field, a “reservation time” field, a “start time” field, an “end time” field and a “settlement charge” field.

The data in each line in this database correspond to the order information for managing the order given from the user. The employee at the restaurant, upon receiving the order from the user, inputs this order on the dish-server terminal 9, whereby the order information is recorded in one line (one record) of the order management database.

The order ID is defined as a unique number for identifying the order of the user. The dish ID is a unique code for identifying a dish, i.e., a menu item as well as being an ID of the cooking database.

The table ID is defined as a unique number for identifying the table. The “reservation hour” field is recorded with a reservation hour when the user makes a reservation beforehand. The reservation time is a time for which the table reserved beforehand by the user is occupied for having the dish concerned.

The start time is a time when the meal is started. The end time is a time when the meal is ended. The settlement charge is a charge for user's eating and drinking, which is calculated based on the charge settlement program.

<Operation and Effect>

FIG. 5 shows the flowchart of the processes from serving the dishes up to transmitting the notification of the end of the meal.

Start with, when the dish ordered is completely cooked in the kitchen, the employee at the kitchen notifies of the completion of cooking, and, with this notification serving as a trigger, the order management system 1 transmits pieces of dish-serving information to the employee (who will hereinafter be called a dish server) in a wait-on-customers task (S1).

The dish-serving information is received by the dish-server terminal 9 of the dish server (S2). Then, the dish server brings the serving dishes together with a receipt of the dishes from a dish serving counter to the user's table and serves the dishes on the table (S3). After serving the dishes, this receipt is given to the user.

This receipt is recorded with the unique code for identifying the order in readable format by an unillustrated reader (e.g., a bar code reader or an OCR (Optical Character Reader)).

After serving the dishes, the dish server transmits a notification of having already served the dished through the dish-server terminal 9 (S4). This notification is received by the order management system 1 (S5).

A process that the order management system 1 refers to the present time and records the present time as a start time of the meal on the order management database, is triggered by the notification of having served the dishes (S6). More specifically, the order management system 1 executes the following processes.

The order management system 1 extracts an order record for managing this order out of the order management database. Next, the order management system 1 requests the time indication program to indicate the time. Next, the order management system 1 outputs the present time indicated by the time indication program to the “start time” field of the order record. Then, the order management system 1 overwrites this order record on the order management database.

In this state, the user when finishing the meal, presses an unillustrated meal end button (S7). A notification of the end of the meal is thereby transmitted to the order management system 1. This end notification is received by the order management system 1 (S8).

Then, the order management system 1 records this end time (S9). To be more specific, the order management system 1 executes the following processes.

The order management system 1 extracts the order record for managing this order out of the order management database. Next, the order management system 1 requests the time indication program to indicate the time. Next, the order management system 1 outputs the present time indicated by the time indication program to the “end time” field of the order record. Then, the order management system 1 overwrites again this order record on the order management database.

Subsequently, the order management system 1 executes a charge settlement (S10). The user pays the charge for the meal in accordance with a result of the charge settlement displayed by the order management system 1 (S11).

FIG. 6 shows details of the charge settlement process (S10 and S11 in FIG. 5). The order management system 1 runs the charge settlement program (see FIG. 1) to execute the process shown in FIG. 6. In this charge settlement process, to begin with, the user shows the receipt (S99). The dish server sets this receipt on or above the order management system 1 to read the code of the receipt (S100).

Then, the order management system 1 extracts the order record specified by this receipt code out of the order management database (S101).

Then, the order management system 1 judges whether the end time is recorded in this order record (S102). This end time is recorded just when the user presses the meal end button when finishing the meal. If the end time is not recorded in the order record, the order management system 1 obtains the present time from the time indication program (S103).

Subsequently, the order management system 1 calculates a time spent for the meal (S104). Then, the order management system 1 calculates the charge for the meal based on this period of time (S105; figure out charge).

Next, the order management system 1 display this charge (S106). On this display, the user confirms the charge (S110) Then, the user pays this charge (S111).

Thereupon, the order management system 1 receives the payment of money through the operation by the dish server (S107), and issues a receipt (S108). The user receives this receipt (S112). Thereafter, the charge settlement process comes to an end.

FIG. 7 shows details of the charge figure out process (S105 in FIG. 6). In this charge figure out process, the order management system 1 at first compares the spent-for-the-meal time with a standard time of this dish (S1050).

Then, if the spent-for-the-meal time calculated is longer than the standard time of the dish, the order management system 1 copies the element data corresponding to the line of this dish in the addition table, to the time table (S1052). In this case, positive values are set in the time table.

Next, a parameter named “pointer” (this parameter will hereinafter be simply called a pointer) is initialized to “0” (S1053).

Next, the order management system 1 judges whether a value in the entry in the time table (this is expressed as “time TBL (pointer)” in FIG. 7) that is indicated by this pointer, is an END mark (S1054).

If the value in this “time table (pointer” is not the END mark, the order management system 1 adds the standard time and the value in the “time TBL (pointer)”, and substitutes the added value into a parameter “comparative time” (S1055). The value of the parameter “comparative time” will hereinafter be simply termed a comparative time.

Then, the order management system 1 judges whether a value in the “CASE” field in the time table is “addition” or not (S1056)

If the value in the “CASE” field is judged to be “addition”, the order management system 1 judges whether the spent-for-the-meal time is longer than the comparative time (S1057).

If the spent-for-the-meal time is longer than the comparative time, the order management system 1 advances the control to S1059 and increments the pointer by “1” (1 unit) (S1059). Then, the order management system 1 loops the control back to the judgement in S1054.

With such processing in S1054 through S1057 and S1059, the order management system 1 increments the pointer till the comparative time exceeds the spent-for-the-meal time, and substitutes the added time of the entry value in the time table indicated by this pointer and the standard time, into the “comparative time”.

Then, when judging in S1057 that the comparative time is longer than the spent-for-the-meal time calculated, a value in the addition table indicated by the present pointer (that is expressed as “addition TBL (pointer)” in FIG. 7), is substituted into a parameter “added charge” (S1060).

Further, a result of adding the value in the parameter “added charge” to the standard charge, is substituted into a parameter “amount of money claimed”. An amount of money claimed is thereby calculated (S1062).

Whereas if judging in S1056 that the “addition” is not entered in the “CASE” field (in the case of a subtraction), the order management system 1 judges whether the spent-for-the-meal time is shorter than the comparative time (S1058).

If the spent-for-the-meal time is shorter than the comparative time, the order management system 1 advances the control to S1059, and increments the pointer by “1” (S1059). Then, the order management system 1 loops the control back to the judgement in S1054.

With such processing in S1054 through S1057 and S1059, the pointer is incremented till the comparative time becomes equal to or shorter than the spent-for-the-meal time, and substitutes the added time of the entry value in the time table indicated by this pointer and the standard time, into the “comparative time”. In this case, however, the value in the time table is a negative value, and hence the comparative time is shorter than the standard time.

Then, when judging in S1058 that the comparative time is not longer than the spent-for-the-meal time calculated, a value in the addition table indicated by the present pointer (that is expressed as “addition TBL (pointer)” in FIG. 7), is substituted into the parameter “added charge” (S1060), and the charge claimed is calculated (S1062).

Moreover, when judging in S1054 that the value in the time table indicated by the pointer is the END mark, the order management system 1 sets a value in the time table (which is expressed as “time TBL (pointer-1)” in FIG. 7) with the pointer pointing back by “1”, in the parameter “added charge” (S1061). This scheme prevents the added charge from increasing and decreasing limitlessly, thus setting the charge claimed within a predetermined range.

Then, the order management system 1 advances the control to S1062, and calculates the charge claimed. Thereafter, the order management system 1 finishes this charge figure-out process.

As discussed above, the eating/drinking charge management system in this embodiment calculates the charge for the meal (eating and drinking) in accordance with the period of time for the meal of the customer. Hence, the charge convincing to the customer, which is calculated corresponding to the occupied time of the table and the seat, can be claimed.

Further, the present eating/drinking charge management system starts counting the meal time upon the completion of serving the dishes, and finishes counting the time upon the customer's pressing the meal end button. The time spent for the meal can be objectively figured out.

Moreover, the present eating/drinking charge management system calculates the amount of money claimed by comparing the spent-for-the-meal time with the set values set for every category of the dish in the addition table and in the subtraction table. It is therefore feasible to elaborately control calculating the amount of money claimed corresponding to the dish item and the overtime value.

Further, the present eating/drinking charge management system is capable of, even if the spent-for-the-meal time is extremely long or short, setting the amount claimed within the predetermined range and thus preventing the amount claimed from increasing or decreasing limitlessly.

<Modified Example>

In the embodiment discussed above, the start of the meal is judged by the operation of the dish server on the dish-server terminal 9. The embodiment of the present invention is not, however, limited to the architecture and procedures described above.

For example, a meal start button may be provided at the table, and the start of the meal may be judged just when the user presses this button. Moreover, the user is ushered to the table seat, and the start of the meal may be judged just when the user sits on the seat.

In the embodiment discussed above, the end of the meal is judged by the user's pressing the end button. Further, if the user does not press the end button, the end of the meal is judged just when the user shows the receipt for paying the charge. The embodiment of the present invention is not, however, confined to the architecture and the procedures described above.

For instance, the meal end button may not be provided, and the end of the meal may be judged just when the user shows the receipt for paying the charge. Alternatively, after the meal, the dish server may input the end of the meal on the dish-server terminal 9 just when the dish-server starts or finishes cleaning the table.

<<Readable-by-Computer Recording Medium>>

The program designed for the computer to execute the processes in the order management system 1 in the embodiment discussed above may be recorded on a readable-by-computer recording medium. Then, the computer reads and executes the program on this recording medium, thereby functioning as the order management system 1 shown in the embodiment discussed above.

Herein, the readable-by-computer recording medium embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

<<Data Communication Signal Embodied in Carrier Wave>>

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to provide the function as the order management system 1.

Herein, the communication media may be any one of cable communication mediums such as metallic cables including a coaxial cable and a twisted pair cable, optical communication cables, or wireless communication media such as satellite communications, ground wave wireless communications, etc. Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. An eating and drinking charge management method comprising:
measuring a seat occupied time for which a customer eats and drinks; and
setting a charge for eating and drinking in accordance with the seat occupied time.

2. An eating and drinking charge management method according t claim 1, wherein said measuring the seat occupied time involves starting counting a time, which is triggered by receiving an eating/drinking start request, and finishing counting the time, which is triggered by an eating/drinking end request.

3. An eating and drinking charge management method according to claim 3, further comprising referring to a standard eating/drinking time for a dish and to a deviation charge corresponding to a deviation time from the standard time,
wherein said setting the charge involves increasing or decreasing the charge for eating and drinking on the basis of a deviation of the seat occupied time of the customer from the standard eating/drinking time for the dish eaten (and drunk) by the customer.

4. A readable-by-computer recording medium recorded with a program executed by a computer to manage a charge for eating and drinking; said program comprising:
measuring a seat occupied time for which a customer eats and drinks; and
setting a charge for eating and drinking in accordance with the seat occupied time.

5. A readable-by-computer recording medium recorded with a program according t claim 4, wherein said measuring the seat occupied time involves starting counting a time, which is triggered by receiving an eating/drinking start request, and finishing counting the time, which is triggered by an eating/drinking end request.

6. A readable-by-computer recording medium recorded with a program according to claim 4, further comprising referring to a standard eating/drinking time for a dish and to a deviation charge corresponding to a deviation time from the standard time,
wherein said setting the charge involves increasing or decreasing the charge for eating and drinking on the basis of a deviation of the seat occupied time of the customer from the standard eating/drinking time for the dish eaten (and drunk) by the customer.

7. An eating and drinking charge management system comprising:
a time measuring unit measuring a seat occupied time for which a customer eats and drinks; and
a unit setting a charge for eating and drinking in accordance with the seat occupied time.

8. An eating and drinking charge management system according t claim 7, wherein said time measuring unit starts counting a time, which is triggered by receiving an eating/drinking start request, and finishing counting the time, which is triggered by an eating/drinking end request.

9. An eating and drinking charge management system according to claim 7, further comprising a unit storing a standard eating/drinking time for a dish and a deviation charge corresponding to a deviation time from the standard time,
wherein said setting unit increases or decreases the charge for eating and drinking by obtaining a deviation charge from a deviation of the seat occupied time of the customer from the standard eating/drinking time for the dish eaten (and drunk) by the customer.
